(19) United States
(12) Patent Application Publication
(10) Pub. No.: US 2024/0279926 A1
(43) Pub. Date: Aug. 22, 2024

(54) CELLULAR GLASS PASSIVE FIRE SUPPRESSION SYSTEM

(71) Applicant: Owens Corning Intellectual Capital, LLC, Toledo, OH (US)

(72) Inventors: Bobby Ferrell, League City, TX (US); Brandon Stambaugh, Export, PA (US); Timothy Bovard, Natrona Heights, PA (US); Alec Cusick, Toledo, OH (US)

(21) Appl. No.: 18/582,846

(22) Filed: Feb. 21, 2024

Related U.S. Application Data
(60) Provisional application No. 63/486,137, filed on Feb. 21, 2023.

(51) Int. Cl. E04C 1/42; A62C 2/06

(52) U.S. Cl. CPC E04C 1/42; A62C 2/06

(57) ABSTRACT

A clad cellular glass block and a passive fire suppression system incorporating clad cellular glass blocks are disclosed. The system is comprised of segments of cellular glass block including a cladding material that comprises an integrated connector flange. Adjacent cellular glass blocks in a reservoir can be interlocked to create a passive barrier the helps to reduce the damage or risks associated with a liquid hydrocarbon spill.

### CROSS-REFERENCE TO RELATED APPLICATIONS

The instant application claims priority to and the benefit of U.S. Provisional application No. 63/486,137, filed on Feb. 21, 2023, the contents of which are hereby incorporated by reference in their entirety.

### FIELD

The present invention relates to fire suppression systems for use with liquid hydrocarbons, and more particularly, to such systems that incorporate buoyant cellular glass.

### BACKGROUND

Industrial hydrocarbon processing and storage facilities run the risk of potentially harmful and expensive fires. Because of this, facilities incorporate various fire prevention and suppression systems. One such system involves a pit or reservoir, into which the hydrocarbon is drained during a failure, in conjunction with a buoyant material that covers the hydrocarbon, reducing vapor pressure of the hydrocarbon, and thereby reducing/preventing fire spread.

Cellular glass is a non-porous closed-cell foam material that is rigid in structure and has a water permeability of zero. Certain densities of cellular glass are buoyant on liquid hydrocarbons (e.g., liquid natural gas). The use of cellular glass as an insulator is well-known, but cellular glass can also be incorporated into passive fire suppression systems to contain hydrocarbon spills before an ignition event to passively suppress vapors, fire, and to reduce the thermal radiation from hydrocarbon fires. This suppression can increase the amount of time a facility has to deploy more “active” firefighting measures, potentially saving lives and damage to adjacent equipment.

### SUMMARY

Conventional Passive Fire Suppression (PFS) systems require substantial labor and time to install, especially when connecting members together to form e.g., a floating barrier or web in a reservoir. In certain systems, segments of buoyant material are positioned in the reservoir in preparation for a potential failure/leak. The individual buoyant segments/blocks of a PFS system are generally linked to avoid gaps in PFS system coverage within a reservoir or pit. This connection process is sometimes tedious/labor intensive and requires many extra parts, each of which must be installed by hand. The general inventive concepts address this issue by reducing/eliminating excess parts and simplifying the installation process, while improving the overall strength and flexibility of the PFS system.

In certain exemplary aspects, the general inventive concepts relate to a clad cellular glass block comprising: a cellular glass block having a density of less than 15 lbs./ft³, the cellular glass block comprising a top surface, a bottom surface, opposing side faces, and opposing end faces. The cellular glass block further includes a cladding material positioned on at least one of the top surface and the bottom surface of the cellular glass block, the cladding material including an integrated connector flange adapted for linking adjacent cellular glass blocks to one another.

The general inventive concepts further relate to a plurality of linked cellular glass blocks, each block having a density of less than 15 lbs./ft³ and comprising a top surface, a bottom surface, opposing side faces, and opposing end faces. The cellular glass block further having a cladding material positioned on at least one of the top surface and the bottom surface of the cellular glass block, the cladding material including a first integrated connector flange and a second integrated connector flange, wherein the integrated connector flanges are adapted for linking adjacent cellular glass blocks to one another, wherein the first integrated connector flange is adapted to mechanically interlock with the second integrated connector flange of an adjacent block, but not with a first integrated connector flange of the adjacent block.

The general inventive concepts further relate to a passive fire suppression system comprising a plurality of cellular glass blocks, each block having a density of less than 15 lbs./ft³, and each block comprising a top surface, a bottom surface, opposing side faces, and opposing end faces. The cellular glass blocks further include a cladding material positioned on at least one of the top surface and the bottom surface of the cellular glass block, the cladding material including a first integrated connector flange and a second integrated connector flange, wherein the integrated connector flanges are adapted for linking adjacent cellular glass blocks to one another, wherein the first integrated connector flange is adapted to mechanically interlock with the second integrated connector flange of an adjacent block, but not with a first integrated connector flange of the adjacent block.

Yet further aspects of the general inventive concepts relate to a liquid hydrocarbon retention vessel. The vessel comprises a reservoir volume defined by at least one vessel wall and a vessel floor, and a passive fire suppression system. The passive fire suppression system comprises a plurality of interlocked cellular glass blocks, each block having a density of less than 15 lbs./ft³, and comprising a top surface, a bottom surface, opposing side faces, and opposing end faces. The cellular glass blocks further include a cladding material positioned on at least one of the top surface and the bottom surface of the cellular glass block, the cladding material including a first integrated connector flange and a second integrated connector flange. The integrated connector flanges are adapted for linking adjacent cellular glass blocks to one another, with the first integrated connector flange being adapted to mechanically interlock with the second integrated connector flange of an adjacent block, but not with a first integrated connector flange of the adjacent block.

The general inventive concepts further relate to a method of interlocking adjacent cellular glass blocks. The method includes providing a cellular glass block comprising a top surface, a bottom surface, opposing side faces, and opposing end faces and positioning a cladding material on at least one of the top surface and the bottom surface of the cellular glass block. The cladding material includes a first integrated connector flange and a second integrated connector flange, with the integrated connector flanges being adapted for linking adjacent cellular glass blocks to one another and the first integrated connector flange being adapted to mechanically interlock with the second integrated connector flange of an adjacent block, but not with a first integrated connector flange of an adjacent block. The method further includes positioning a first cellular glass block adjacent to a second cellular glass block such that the first integrated connector flange of the first cellular glass block interlocks with the second integrated connector flange of the second cellular glass block.

Further aspects of the general inventive concepts relate to a method of preventing fire spread and/or suppressing fire in a liquid hydrocarbon retention vessel comprising a reservoir volume defined by at least one vessel wall and a vessel floor. The method comprises positioning a passive fire retention system within the reservoir volume by interlocking a plurality of cellular glass blocks to form a passive fire suppression system having an area that substantially corresponds to the area of the vessel floor. The passive fire suppression system comprises a plurality of interlocked cellular glass blocks, each block having a density of less than 15 lbs./ft³, and comprising a top surface, a bottom surface, opposing side faces, and opposing end faces; and a cladding material positioned on at least one of the top surface and the bottom surface of the cellular glass block, the cladding material including a first integrated connector flange and a second integrated connector flange, wherein the integrated connector flanges are adapted for linking adjacent cellular glass blocks to one another, wherein the first integrated connector flange is adapted to mechanically interlock with the second integrated connector flange of an adjacent block, but not with a first integrated connector flange of an adjacent block, and wherein a first cellular glass block is positioned adjacent to a second cellular glass block, such that the first integrated connector flange of the first cellular glass block interlocks with the second integrated connector flange of the second cellular glass block.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is a diagram of a conventional cellular glass block with a cladding positioned on a top surface.

FIG. 2 is a diagram of a plurality of conventional cellular glass blocks positioned adjacent to one another.

FIG. 3 is a diagram of conventional adjacent cellular glass blocks and a connector strip positioned along an interface between the blocks.

FIG. 4 is a diagram of a clad cellular glass block according to the general inventive concepts.

FIG. 5 is a diagram showing interlocking flanges on adjacent cellular glass blocks.

FIG. 6A is a close-up diagram of an integrated connector flange according to the general inventive concepts.

FIG. 6B is a diagram showing integrated connector flanges of adjacent cellular glass blocks interlocked with one another.

FIG. 7A is a close-up diagram of an integrated connector flange according to another exemplary embodiment of the general inventive concepts.

FIG. 7B is an image showing interlocking of integrated connector flanges of adjacent cellular glass blocks interlocked with one another.

FIG. 8 shows a top view of an integrated connector flange comprising drainage holes.

FIG. 9A shows a clad cellular glass block according to the general inventive concepts.

FIG. 9B is a close-up of a portion of the clad cellular glass block of FIG. 9A.

FIG. 10 shows a series of clad cellular glass blocks arranged in rows in a PFS system.

FIG. 11 shows a series of clad cellular glass blocks arranged in rows in a PFS system.

FIG. 12 shows a clad cellular glass block according to the general inventive concepts.

FIG. 13 shows a series of clad cellular glass blocks arranged in rows in a PFS system.

FIG. 14 shows a series of clad cellular glass blocks arranged in overlapping rows in a PFS system with reinforcing fasteners positioned to connect adjacent clad cellular glass blocks through drainage holes in the connector flanges.

FIG. 15 shows an exemplary reinforcing fastener (e.g., pin) for use in accordance with the PFS systems described herein.

FIG. 16 is a top view of clad cellular glass blocks arranged in overlapping rows in a PFS system with reinforcing fasteners positioned in drainage holes in adjacent cellular glass blocks.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

While various exemplary embodiments are described or suggested herein, other exemplary embodiments utilizing a variety of methods and materials similar or equivalent to those described or suggested herein are encompassed by the general inventive concepts.

Unless defined otherwise, all technical and scientific terms used herein have the same meaning as commonly understood by one of ordinary skill in the art to which the invention belongs.

PFS systems using cellular glass blocks are deployed, generally in a pit or reservoir, prior to an ignition event to provide fire control and suppression. In certain exemplary embodiments, the general inventive concepts contemplate direct placement of cellular glass within the areas/reservoirs designed to contain hydrocarbon spills. Therefore, the compositions, systems, and methods could be used to provide safety for liquids such as LNG, LPG, or any other related flammable liquid(s). PFS systems are predicated on the concept of reducing the area available for vaporization and flame spread (e.g., by covering the surface of the hydrocarbon).

The general inventive concepts are based on the recognition that a buoyant glass product positioned on the surface of a hydrocarbon fire will lower the risks associated with a fire. Certain conventional systems use small cubes/pieces of cellular glass, whereas the instant system 1) provides better coverage over the flammable liquid, further reducing the risk of fire, 2) provides better interlocking of adjacent blocks to ensure that the blocks a consistent distance from the adjacent block and that movement of the blocks is constrained to a great degree, while allowing for some movement and flexibility, avoiding an unnecessarily rigid structure, 3) increases the strength and resilience of the system, and 4) provides reduced installation time installation time compared to systems that require mechanical fastening of adjacent blocks/rows to one another.

Some benefits of cellular glass when used in a PFS system include: 1) it is “solid foam” that acts as a floating barrier to insulate a burning liquid surface; 2) it is a non-flammable material; 3) it floats on most flammable liquid hydrocarbon surfaces which means it will remain on the surface independent of the reservoir depth, no liquids are absorbed during contact with hydrocarbons (it will not sink due to absorption of liquid); 4) it is mechanically stable at flame temperature; 5) it is impervious to water vapor; 6) it is acid resistant; 7) it is easily cut to shape, and 8) it is dimensionally stable and thus can be arranged to take the shape of the desired coverage area.

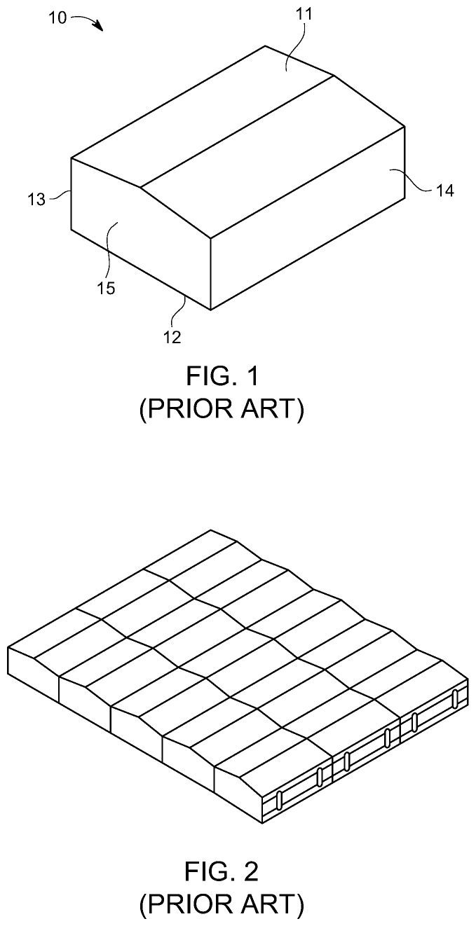

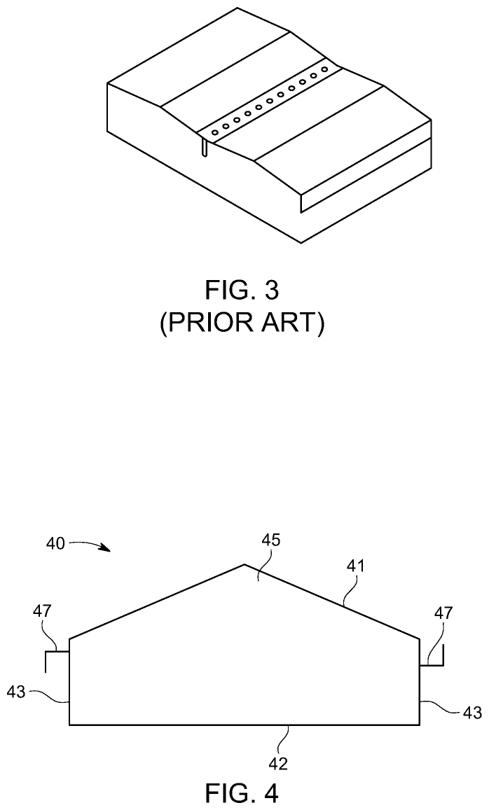

FIG. 1 shows an embodiment of a conventional cellular glass block 10. The block 10 comprises a top surface 11, a bottom surface 12, opposing side faces 13 and 14, and opposing end faces 15 and 16 (not shown). A cladding material provides environmental protection to the block. FIG. 2 shows a plurality of clad blocks arranged to cover an area e.g., a reservoir floor. FIG. 3 shows two cellular glass blocks, arranged side-by-side along adjoining faces and a conventional connector strip extending along the adjoining side faces of the two blocks. The connector strip comprises a strip of material e.g., metal, and as shown, includes a series of drainage holes. The connector strip provides a means for attaching adjacent blocks to one another. However, as previously mentioned, these conventional connection means require substantial installer time and effort as the connectors are generally attached with mechanical fasteners (e.g., screws) which are manually installed on-site. Depending on the size of the reservoir, this often entails installation of hundreds to thousands of screws to properly install the system. Additionally, conventional connection means are limited in strength, due to the use of mechanical fasteners such, as screws.

The general inventive concepts seek to address the drawbacks of conventional systems by introducing articles, systems, and methods that improve on conventional PFSs systems. One particular form of improvement involves an improved means for connecting adjacent cellular glass blocks to one another using an integrated connector flange. In certain embodiments, individual cellular glass blocks that make up a PFS system include a cladding material positioned on at least one surface of each block, with the cladding material including an integrated connector flange adapted for linking adjacent cellular glass blocks to one another. Consequently, few, if any, mechanical fasteners are needed.

However, in certain instances it is desirable to provide additional reinforcement of the connection between adjacent clad cellular glass blocks or rows of clad cellular glass blocks. In such instances, a reinforcement fastener (e.g., a pin) may be inserted thru at least one drainage holes of a first clad cellular glass block and thru a drainage hole of a second clad cellular glass block, thereby interlocking the blacks together and reinforcing the relative position of the blocks. This may be repeated throughout the PFS system to achieve the desired level of interlocking, up to connecting each clad cellular glass block to at least one other clad cellular glass block.

In accordance with the general inventive concepts, a clad cellular glass block is provided having a density of less than 15 lbs./ft³ and comprises a top surface, a bottom surface, opposing side faces, and opposing end faces. The clad cellular glass block further includes a cladding material positioned on at least one of the top surface, the bottom surface, and an end surface of the cellular glass block. The cladding material includes an integrated connector flange adapted for linking adjacent cellular glass blocks to one another. In certain exemplary aspects, the cladding material includes a first integrated connector flange and a second integrated connector flange, wherein the first integrated connector flange is adapted to mechanically interlock with the second integrated connector flange of an adjacent block, but not with a first integrated connector flange of an adjacent block.

The general inventive concepts further relate to a PFS system comprising a plurality of such cellular glass blocks, a liquid hydrocarbon retention vessel comprising a reservoir volume defined by at least one vessel wall and a vessel floor, and a passive fire suppression system comprising a plurality of interlocking cellular glass blocks, along with a method of interlocking adjacent cellular glass blocks in such a PFS system. In such a method, the integrated connector flanges are adapted for linking adjacent cellular glass blocks to one another, and the first integrated connector flange is adapted to mechanically interlock with the second integrated connector flange of an adjacent block, but not with a first integrated connector flange of an adjacent block. A first cellular glass block is positioned adjacent to a second cellular glass block, such that the first integrated connector flange of the first cellular glass block interlocks with the second integrated connector flange of the second cellular glass block.

The general inventive concepts further relate to a method of preventing fire spread and/or suppressing fire in a liquid hydrocarbon retention vessel comprising a reservoir volume defined by at least one vessel wall and a vessel floor. The method comprises positioning a passive fire suppression system within the reservoir volume by interlocking a plurality of cellular glass blocks to form a passive fire suppression fire system defining an area that substantially corresponds to the area of the vessel floor. The passive fire suppression system comprising a plurality of interlocked cellular glass blocks, each block having a density of less than 15 lbs./ft³, the cellular glass block comprising a top surface, a bottom surface, opposing side faces, and opposing end faces; a cladding material positioned on at least one of the top surface and the bottom surface of the cellular glass block, the cladding material including a first integrated connector flange and a second integrated connector flange, wherein the integrated connector flanges are adapted for linking adjacent cellular glass blocks to one another, wherein the first integrated connector flange is adapted to mechanically interlock with the second integrated connector flange of an adjacent block, but not with a first integrated connector flange of an adjacent block. wherein a first cellular glass block is positioned adjacent to a second cellular glass block such that the first integrated connector flange of the first cellular glass block interlocks with the second integrated connector flange of the second cellular glass block.

Cellular glass is a material composed primarily of glass that contains a significant number (i.e., all or substantially all) of closed cells in the material, which serves to form a lower density material than an otherwise solid glass product. The closed cell nature of cellular glass prevents fuel absorption into the block and thus premature system failure due to the cellular glass sinking in the liquid hydrocarbon. While the density of cellular glass products can vary widely, when used in a passive fire suppression system, cellular glass may generally range in density from three pounds per cubic foot of (3 lbs./ft³) up to the density of the hydrocarbon/fuel on which it will ultimately need to float. Thus, in any of the exemplary aspects, the cellular glass has a density of 3 lbs./ft³ to 15 lbs./ft³, including about 7-8 lbs./ft³. In certain exemplary aspects, the cellular glass has a density of greater than 3 lbs./ft³. In certain exemplary aspects, the cellular glass has a density of greater than 4 lbs./ft³. In certain exemplary aspects, the cellular glass has a density of greater than 5 lbs./ft³. In certain exemplary aspects, the cellular glass has a density of greater than 6 lbs./ft³. In certain exemplary aspects, the cellular glass has a density of less than 15 lbs./ft³. In certain exemplary aspects, the cellular glass has a density of less than 10 lbs./ft³. In certain exemplary aspects, the cellular glass has a density of less than 9 lbs./ft³. In certain exemplary aspects, the cellular glass has a density of less than 8 lbs./ft³. In certain exemplary aspects, the cellular glass has a density of less than 7.9 lbs./ft³. In certain exemplary aspects, the cellular glass has a density of less than 7.8 lbs./ft³. In certain exemplary aspects, the cellular glass has a density of less than 7.7 lbs./ft³. In certain exemplary aspects, the cellular glass has a density of less than 7.6 lbs./ft³. In certain exemplary aspects, the cellular glass has a density of less than 7.5 lbs./ft³. In certain exemplary aspects, the cellular glass has a density of less than 7.4 lbs./ft³. Those of ordinary skill in the art will recognize that the greater the difference between the density of cellular glass and that of the fuel, the more buoyant the cellular glass system will be in the system.

The cellular glass may be in block, sheet, flat, or in certain instances, tapered configurations. Individual blocks typically are no more than a few feet in length or width and no more than twelve inches thick.

An exemplary cellular glass block for use in a PFS system according to the general inventive concepts is shown in FIG. 4. As can be seen from the figure, the block 40 comprises a top surface 41, a bottom surface 42, opposing side faces 43 and 44, and opposing end faces 45 and 46 (not shown). While the figure shows a tapered top surface that tapers from a peak running along the length of the top surface (i.e., where portions of the top surface taper downward from a midline to the side faces), those of ordinary skill will understand that a variety of shapes are contemplated and fall within the general inventive concepts (e.g., tapering from a high point on one side or the other, pyramidal shape, no tapering, rounded, etc.). An important feature of the blocks (and, correspondingly, the PFS system) is that a sloped/tapered design allows drainage from the upper surface to the bottom of the block/system. A sloped/tapered drainage design is beneficial for both environmental conditions such as rain as well as for incidents where combustible liquids are spilled on the top surface of the block. A tapered configuration of the blocks allows spilled flammable liquids to more readily flow downward, ultimately to the bottom of the cellular glass, whereby the buoyancy of the cellular glass causes the PFS system to float on the liquid. Tapered in this application refers to a configuration wherein two surfaces slope downwardly away from a midline having an upper height to a lower height, which can be defined e.g., by another side or the bottom of the block/segment.

The cellular glass block is clad on at least one of the top and bottom surfaces (and in certain instances, both the top and bottom surfaces of the block) and the cladding comprises at least one integrated connector flange 47. The cladding material may comprise any material, such as metal. Exemplary metals suitable for use as the cladding material described herein include aluminum and/or stainless steel. In certain exemplary aspects, the cladding is formed from 316 stainless steel. In certain exemplary aspects, the stainless steel cladding has a gauge of approximately 0.16″. Metal cladding is not flammable, allows workers to walk on the surface, and creates a simple method for environmental protection.

The cellular glass blocks may include a surface coating/film on one or more surfaces or faces of the blocks to improve weatherability, adhesion to the cladding, and fire control. In some exemplary embodiments, each surface and face of the cellular glass blocks are coated with the surface coating/film. These coatings or films may comprise, for example, silicone, UV resistant polymers, and/or intumescent materials. In certain exemplary aspects, the coating or film comprises a silicone material, which acts as an environmental barrier and adheres the cladding to the cellular glass block when positioned between the cladding and the glass.

In the embodiment shown in FIG. 4, the cladding comprises a first integrated connector flange and second integrated connector flange 47. As can be seen, the connector flanges are adapted to mechanically interlock with a corresponding connector flange of an adjacent block. As shown in FIG. 4, the integrated connector flanges 47 will interlock with flanges of an opposing arrangement (herein one facing upward and the other facing downward, relative to the top surface of the block), but will not interlock with an integrated connector flange of the same arrangement/positioning. In certain aspects, this is achieved by positioning the integrated connector flanges wherein the first integrated connector flange is at a different height on the block (e.g., higher than a horizontal axis) than the second integrated connector flange. In the embodiment of FIG. 4, the downward facing integrated connector flange is positioned slightly higher than the upward facing integrated connector flange.

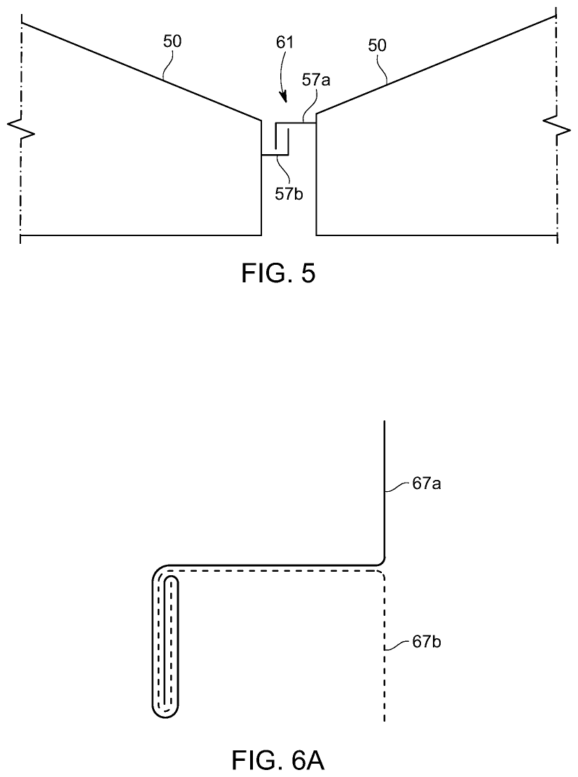

FIG. 5 shows an exemplary embodiment of adjacent cellular glass blocks interlocked together with integrated connector flanges. As can be seen, the cellular glass blocks 50 are mechanically interlocked by the overlap of the integrated connector flanges 57a and 57b. In this way, blocks may be arranged and interlocked in rows in a reservoir to form a PFS system. In certain exemplary embodiments, the integrated connector flange(s) 57a,b may extend a portion of the length of the side face, including up to the entire length of the cladding material, including the entire length of the side face of the cellular glass block. In certain exemplary aspects, the flange may have a height of less than 1 inch, including a height from about ⅜ to ¾ inch. In certain exemplary aspects, the flange may have a width (i.e., the distance from the side of the cladding to the end of the flange) of about 1 inch, including about ½ inch to about 1 inch or more.

As illustrated in FIG. 5, the use of integrated connector flanges in accordance with the present disclosure creates a gap 61 between two adjacent cellular glass blocks. It is important to maintain a minimum gap width and that the width remain relatively consistent between each adjacent cellular glass block in the system. In some exemplary embodiments, the gap between two adjacent cellular glass blocks is at least 0.25 inches, including, for example, at least 0.5 inches, 0.75 inches, 0.9 inches, 1.0 inch, 1.25 inches, 1.5 inches, and at least 1.75 inches. In some exemplary embodiments, the gap between two adjacent cellular glass blocks is between 0.25 inches and 5 inches, including, for example, between 0.6 inches and 4.0 inches, between 0.8 inches and 3.5 inches, between 0.9 inches and 3.25 inches, between 1.0 inches and 3.0 inches, between 1.25 and 2.75 inches, and between 1.5 inches and 2.5 inches. It was surprisingly discovered that maintaining a gap between two adjacent cellular glass blocks between 0.25 inches and 3.5 inches provides the necessary balance between desired barrier properties and material flexibility of the system.

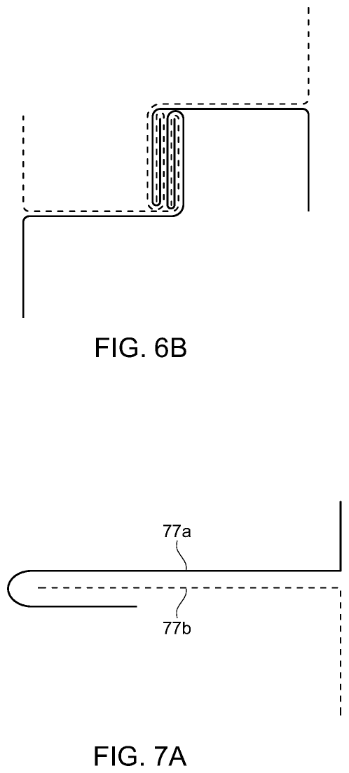

The interlocking of the integrated connector flanges serves both to decrease installation time, as no mechanical fasteners are required to constrain the lateral movement of adjacent blocks relative to one another, and to increase overall strength of the system. FIG. 6 shows a close-up view of an integrated connector flange (e.g., the integrated connector flange 57a of FIG. 5). In the embodiment shown in FIG. 6B, a portion of the cladding positioned on the top surface 67a of the cellular glass block (not shown) is folded together with a portion of the cladding positioned on the bottom surface 67b of the cellular glass block. Thus, the flange consists of at least 2 layers, which substantially improves the strength of the flange and thus the system as a whole. In certain exemplary embodiments, a corresponding but opposing integrated connector flange could be formed on the opposing side face of the cellular glass block. In this way the integrated connector flanges form a seam along the cellular glass block.

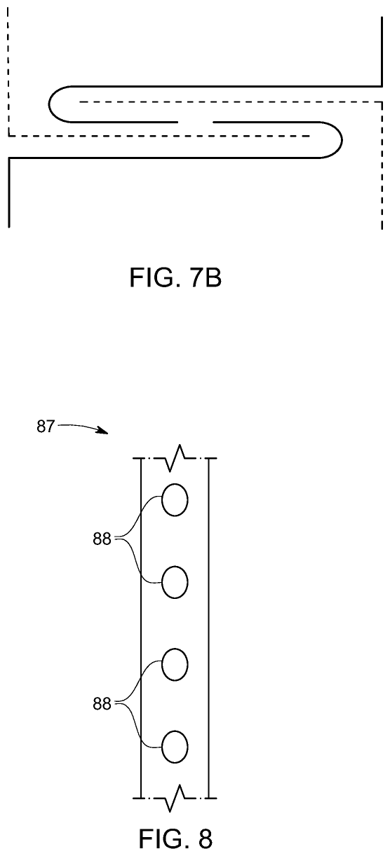

FIG. 7 shows an embodiment wherein the integrated connector flange is formed into a substantially horizontal seam. In other words, the cladding from the material positioned on the top surface 77a and the material positioned on the bottom surface 77b are folded together to form an integrated connector flange that is substantially parallel with the bottom surface and/or perpendicular with the side face of the cellular glass block. FIG. 7B shows an embodiment of mechanical interlocking between a substantially horizontal first integrated connector flange a substantially horizontal second integrated connector flange on adjacent cellular glass blocks. While embodiments have been shown with both substantially vertical and substantially horizontal interconnection, those of ordinary skill in the art will recognize that a variety of angles of interconnection between adjacent flanges are envisioned and encompassed by the general inventive concepts.

FIG. 8 shows a top view of an integrated connector flange 87 according to the general inventive concepts. In certain embodiments, the integrated connector flange includes drainage holes 88 along the length of the flange. These may be incorporated regardless of the arrangement/shape of the integrated connector flange. The number and position of the drainage holes may vary according to the particular design of the PFS system. In certain embodiments, the drainage holes are positioned across only a portion the length of the integrated connector flange. In certain embodiments, the flange comprises a plurality of drainage holes which are positioned across substantially the entire length of the integrated connector flange. The drainage holes may be positioned such that, when installed, they substantially overlap with drainage holes in an integrated connector flange of a corresponding adjacent cellular glass block. In certain embodiments, the drainage holes may be positioned such that there is only partial or no substantial overlap with drainage holes in an integrated connector flange of an adjacent cellular glass block.

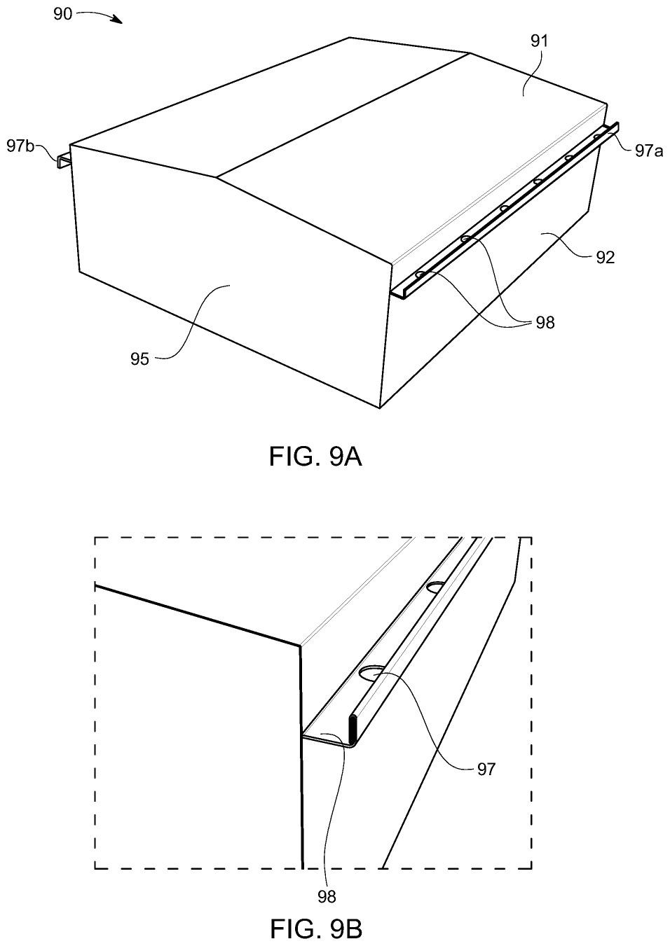

FIG. 9A shows a perspective view of a cellular glass block 90 according to an exemplary embodiment of the general inventive concepts. The block includes metal cladding positioned on the top surface 91 and bottom surface 92 of the block, extending up the side faces, whereas the end face 95 does not include cladding in this embodiment. The top and bottom cladding is formed into integrated connector flanges 97a and 97b, which may also include drainage holes 98 formed therethrough. FIG. 9B is a close-up of the integrated connector flange 97 with drainage holes 98 of FIG. 9A.

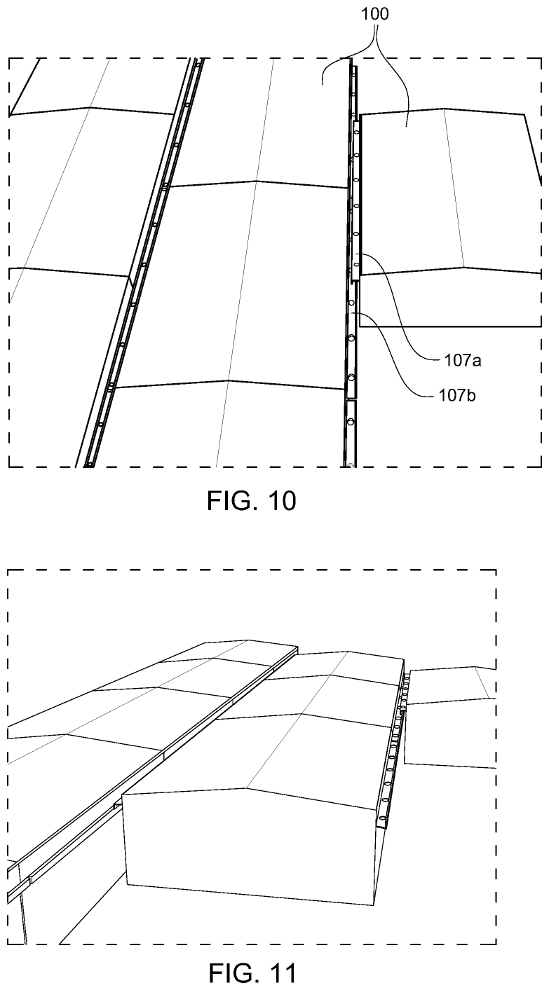

FIG. 10 shows a perspective view of a series of clad cellular glass blocks positioned in a reservoir to form a PFS system. The integrated connector flanges of adjacent cellular glass blocks are interlocked from one row to the next. In certain exemplary embodiments, the rows of cellular glass blocks in the PFS system may be arranged such that there is not overlap in the seams between adjacent blocks from one row to the next. Likewise, FIG. 11 shows rows of interlocked cellular glass blocks according to exemplary embodiments of the general inventive concepts. The blocks are arranged in a reservoir as a part of a PFS system.

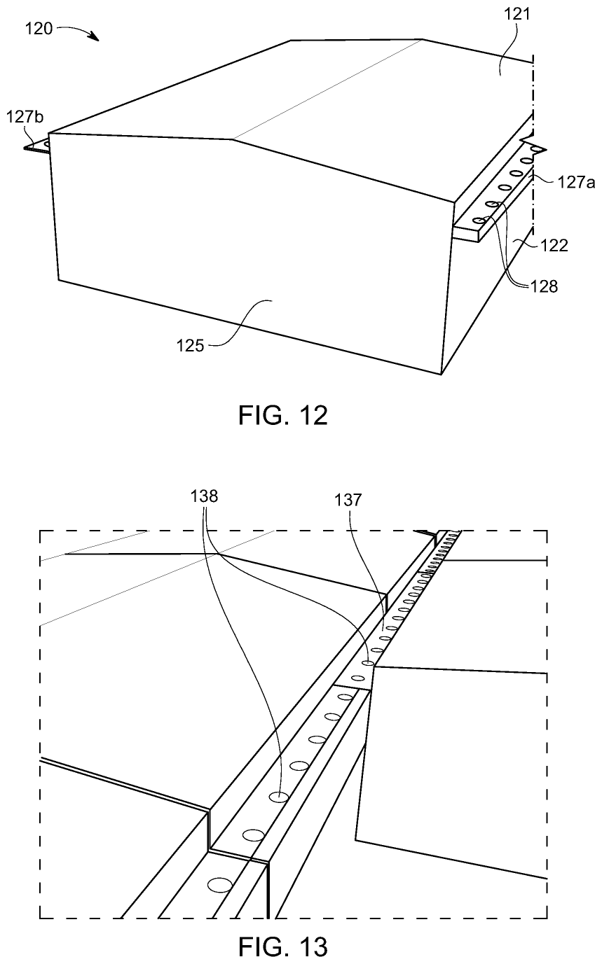

FIG. 12 shows a perspective view of a cellular glass block 120 according to an exemplary embodiment of the general inventive concepts. The block includes metal cladding positioned on the top surface 121 and bottom surface 122 of the block, extending up the side faces, whereas the end face 125 does not include cladding in this embodiment. The top and bottom cladding is formed into integrated connector flanges 127a and 127b (here shown as substantially horizontal flanges, relative to the bottom surface of the block). The flanges may also include drainage holes 128 formed therethrough.

FIG. 13 shows a perspective view of a series of clad cellular glass blocks according to the embodiment shown in FIG. 12, positioned in a reservoir floor to form a PFS system. The integrated connector flanges of adjacent cellular glass blocks are interlocked from one row to the next. As can be seen form the figure, the drainage holes 138 of a first integrated connector flange of a first clad cellular glass block are positioned to substantially overlap with the drainage holes of the adjacent cellular glass block. In certain exemplary embodiments, the rows of cellular glass blocks in the PFS may be arranged such that there is no overlap in the seams between adjacent blocks from one row to the next.

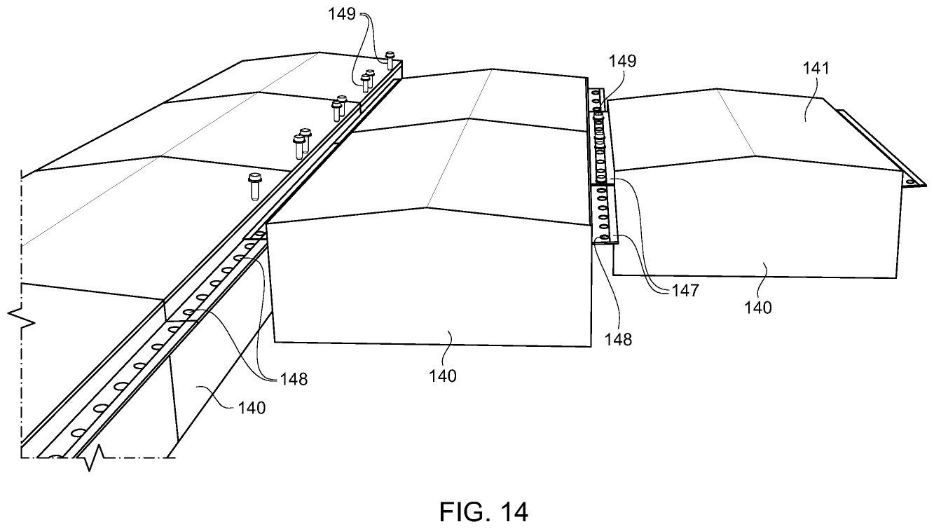

In some instances it is desirable to further reinforce the connection between individual cellular blocks and between rows of blocks in a PFS. For example, a PFS positioned in a reservoir is exposed to the elements. As the reservoir may be arranged to receive flow of e.g., LNG from a tank, it is also exposed to rain and corresponding run-off. During more severe weather, the reservoir may receive substantial amounts of rain or run-off, even enough to displace individual blocks form their intended arrangement in the PFS. When this happens repairs must be initiated to reposition the blocks to maintain the integrity and fire suppressive properties of the PFS. Thus, it may be desirable to provide means to further reinforce the connection (e.g., fasteners) between blocks and between rows in the PFS. FIG. 14 is a side perspective view showing an embodiment of a PFS positioned in a reservoir, wherein fasteners 149 are inserted into drainage holes 148 in adjacent clad cellular glass blocks according to the general inventive concepts. As can be seen from the figure, each fastener (e.g., pin) is positioned to fit within the overlapping portion of drainage holes 148 in adjacent blocks 140. In this embodiment, a fastener is inserted through the drainage hole at the outermost edge of the flange 147. Pins are also inserted near to the middle of one block in order to meet the outermost drainage hole of the block in the adjacent row. Those of ordinary skill in the art will recognize that a variety of different numbers and arrangements of pins and pin placement(s) are possible while still falling under the general inventive concepts, provided that their placement does not prevent or substantially interfere with the proper functioning of the PFS (e.g., preventing drainage).

Further, when methods of interlocking or installation employ a PFS system comprising reinforcing fasteners, the methods further comprise installing at least one reinforcing fastener. In certain exemplary embodiments, the methods may comprise: aligning adjacent clad cellular glass blocks (e.g., in an overlapping fashion in adjacent rows) and positioning at least one reinforcing fastener in a drainage hole of a first clad cellular glass block and a drainage hole of a second clad cellular glass block, such that the pin passes through each hole. In certain exemplary embodiments, this step may be repeated to connect multiple clad cellular glass blocks, up to and including connecting each clad cellular glass block to at least on other clad cellular glass block.

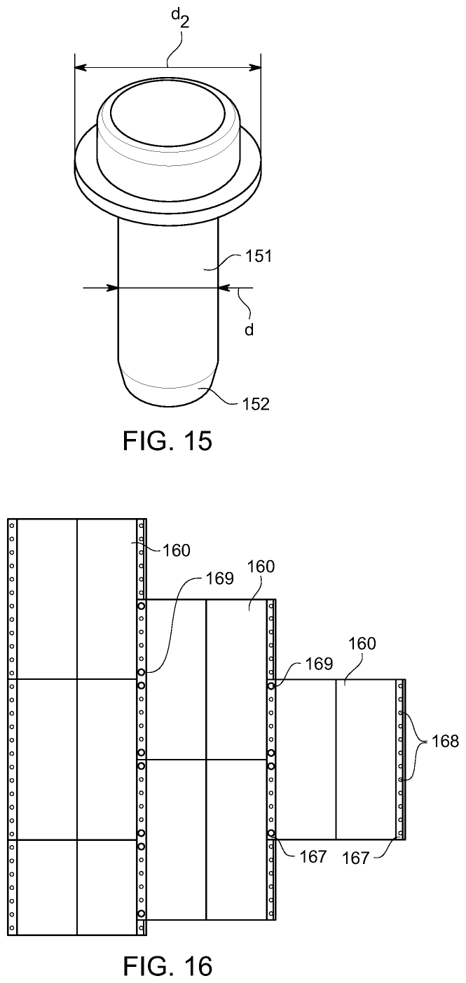

FIG. 15 shows an embodiment of a pin according to the general inventive concepts. Pin 159 has a first diameter d along a cylindrical portion 151 that is smaller than the diameter of the drainage holes in the connector flanges. The top of the pin also includes a head, having a diameter d2 larger than that of the drainage holes to prevent the pin from falling thru the drainage hole. In this embodiment, pin 159 also includes a lower portion 152 having a tapered frustoconical shape narrowing from d to d3. This tapered shape facilitates installation of the pin in the PFS. Those of ordinary skill in the art will recognize that a variety of different shapes and sizes of fasteners (e.g., pin) are possible while still falling under the general inventive concepts.

FIG. 16 is a top view of a passive fire suppression system according to the general inventive concepts. The PFS includes a plurality of individual clad cellular glass blocks 160 arranged in overlapping rows. The cladding on the cellular glass blocks includes connector flanges 167 on two sides of each block. Each of the flanges comprises a series of drainage holes 168. In this embodiment, the blocks are positioned such that drainage holes of one clad cellular glass block overlap with drainage holes in an adjacent clad cellular glass block. Within the holes are fasteners 169 (e.g., pins) for reinforcing the connection between individual clad cellular glass blocks and between rows.

In certain exemplary aspects, the passive fire suppression system further comprises a support structure on an underside of the cellular glass blocks. The support structure can take a variety of forms and serves to provide a gap between the bottom of the cellular glass blocks and the floor of a pit/reservoir to allow for liquid hydrocarbon to flow. In certain exemplary aspects, the support structure can take the form of blocks, pipes, and/or channels, which are positioned between the blocks and the reservoir. In certain exemplary aspects, the support can be installed or otherwise integrated into the blocks themselves. In one such embodiment, the support structure comprises screws inserted into the bottom side of the cellular glass blocks, where a portion of the screw(s) extends from the block. In certain aspects, it is advantageous to maintain this space to allow for the flow/drainage of the liquid hydrocarbon into the system and under the cellular glass blocks to further prevent/suppress a fire.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The cellular glass compositions, and corresponding methods of the present disclosure can comprise, consist of, or consist essentially of the essential elements and limitations of the disclosure as described herein, as well as any additional or optional ingredients, components, or limitations described herein or otherwise useful in cellular glass composition applications.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some aspects, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

1. A clad cellular glass block comprising:
a cellular glass block having a density of less than about 15 lbs./ft³, the cellular glass block having a top surface, a bottom surface, two opposing side faces, and two opposing end faces;
and a cladding material positioned on at least one of the top surface and the bottom surface of the cellular glass block, the cladding material including at least one integrated connector flange adapted for linking the clad cellular glass block to an adjacent clad cellular glass block.

2. The clad cellular glass block of claim 1, wherein the cladding material is positioned on both the top surface and the bottom surface of the cellular glass block, wherein the cladding material positioned on the top surface contacts the cladding material on the bottom surface to form the integrated connector flange.

3. The clad cellular glass block of claim 1, wherein the integrated connector flange comprises at least one drainage hole.

4. The clad cellular glass block of claim 3 further comprising at least one reinforcing fastener positioned within the at least one drainage hole.

5. The clad cellular glass block of claim 1, wherein the cladding material comprises stainless steel.

6. The clad cellular glass block of claim 5, wherein the top surface tapers from a peak that runs the length of the top surface.

7. The clad cellular glass block of claim 5, wherein the cladding material is positioned on the top surface and has a shape to substantially match the tapered top surface.

8. The clad cellular glass block of claim 1 further comprising a surface coating on at least one surface of the block.

9. The clad cellular glass block of claim 1, wherein the cellular glass block has a density of 7 lbs./ft³ to 8 lbs./ft³.

10. A passive fire suppression system comprising a plurality of cellular glass blocks positioned in a reservoir, each block having a density of less than 15 lbs./ft³, and each block comprising a top surface, a bottom surface, opposing side faces, and opposing end faces;
a cladding material positioned on at least one of the top surface and the bottom surface of each cellular glass block, the cladding material including a first integrated connector flange and a second integrated connector flange, wherein the integrated connector flanges are adapted for linking cellular glass blocks from a first row to cellular glass blocks in an adjacent row,
wherein the first integrated connector flange of a first cellular glass block is adapted to mechanically interlock with the second integrated connector flange of a second cellular glass block, but not with a first integrated connector flange of the second cellular glass block.

11. The passive fire suppression system of claim 10, wherein the cladding material is positioned on both the top surface and the bottom surface of the cellular glass block, wherein the cladding material positioned on the top surface contacts the cladding material on the bottom surface to form the integrated connector flange.

12. The passive fire suppression system of claim 10, wherein the integrated connector flange comprises at least one drainage hole.

13. The passive fire suppression system of claim 12 further comprising at least one reinforcing fastener positioned within at least one drainage hole of a first clad cellular glass block and passing thru a drainage hole of a second clad cellular glass block.

14. The passive fire suppression system claim 10, wherein the cladding material comprises stainless steel.

15. The passive fire suppression system of claim 14, wherein the top surface tapers from a peak that runs the length of the top surface.

16. The passive fire suppression system of claim 15, wherein the cladding material is positioned on the top surface and has a shape to substantially match the tapered top surface.

17. The passive fire suppression system of claim 16 further comprising a surface coating on at least one surface of the block.

18. The passive fire suppression system of claim 17, wherein the surface coating adheres the cladding material to the top surface of the block.

19. A method of preventing fire spread and/or suppressing fire in a liquid hydrocarbon retention vessel comprising a reservoir volume defined by at least one vessel wall and a vessel floor, the method comprising:
positioning a passive fire retention system within the reservoir volume by interlocking a plurality of cellular glass blocks to form a passive fire suppression fire system defining an area that substantially corresponds to the area of the vessel floor;
the passive fire retention system comprising a plurality of interlocked cellular glass blocks, each block having a density of less than 8 lbs./ft³, the cellular glass block comprising a top surface, a bottom surface, opposing side faces, and opposing end faces; a stainless steel cladding material positioned on at least one of the top surface and the bottom surface of the cellular glass blocks,
the cladding material including a first integrated connector flange and a second integrated connector flange, wherein the integrated connector flanges are adapted for linking adjacent cellular glass blocks to one another, wherein the first integrated connector flange is adapted to mechanically interlock with the second integrated connector flange of an adjacent block, but not with a first integrated connector flange of the adjacent block,
wherein a first cellular glass block is positioned adjacent to a second cellular glass block such that the first integrated connector flange of the first cellular glass block interlocks with the second integrated connector flange of the second cellular glass block.

20. The method of preventing fire spread and/or suppressing fire according to claim 19, wherein the integrated connector flanges comprise at least one drainage hole, positioning at least one reinforcing fastener within at least one drainage hole of a first clad cellular glass block and passing thru a drainage hole of a second clad cellular glass block.
